(19) United States
(12) Patent Application Publication
(10) Pub. No.: US 2011/0163987 A1
(43) Pub. Date: Jul. 7, 2011

(54) Systems and Methods for Facilitating Finger Placement on a Touch Pad and the Surrounding Areas

(76) Inventor: Kelvin Williams, East Rutherford, NJ (US)

(21) Appl. No.: 12/985,755

(22) Filed: Jan. 6, 2011

Related U.S. Application Data
(60) Provisional application No. 61/293,049, filed on Jan. 7, 2010.
(60) Provisional application No. 61/418,079, filed on Nov. 30, 2010.

(51) Int. Cl. G06F 3/041

(52) U.S. Cl. 345/173

(57) ABSTRACT

Systems and methods for facilitating touch pad finger placement including systems and methods for identifying the perimeters of a touch pad and various locations adjacent thereto to facilitate finger placement upon a touch pad and the surrounding areas. Systems include a border surrounding a perimeter of a touch pad and/or one or more pegs located in an area adjacent to the touch pad and/or border. Methods include affixing a border and/or one or more pegs to a touch pad and/or its surrounding area to alert a user when his or her finger(s) have strayed too far from a desired position or to assist a user in proper finger placement relative to the attached border and/or one or more pegs.

### CROSS-REFERENCE TO RELATED APPLICATIONS

This application claims the benefit of the U.S. provisional patent applications entitled “Touch Point”, having Ser. Nos. 61/293,049 (filed Jan. 7, 2010) and 61/418,079 (filed Nov. 30, 2010), and currently pending, which are hereby incorporated by reference in their entireties as if fully set forth herein.

### BACKGROUND OF THE INVENTION

Embodiments of the present invention generally relate to systems and methods for facilitating touch pad finger placement. More specifically, the present invention relates to systems and methods for identifying the perimeters of a touch pad and various locations adjacent thereto to facilitate touch pad finger placement.

When working on a laptop, users have a tendency to look down at the control area of the keyboard to ensure that their fingers are still in contact with the touch pad. It is frustrating and inconvenient to constantly check the placement of one's hand while navigating a cursor via a touch pad. Due to the sleek design of many touch pads, it is often difficult to tell if a finger is still on the touch pad, or if it has strayed to a non-functional area of the computer.

### BRIEF SUMMARY OF THE INVENTION

Briefly stated, in one aspect of the present invention, a system for facilitating touch pad finger placement is provided. This system includes: a border, the border including a top border face and a bottom border face; and an attachment mechanism coupled to the bottom border face.

In another aspect of the present invention, a system for facilitating touch pad finger placement is provided. This system includes: at least one peg, the peg including a top peg face and a bottom peg face; and an attachment mechanism coupled to the bottom peg face.

In a further aspect of the present invention, a system for facilitating touch pad finger placement is provided. This system includes: a border, the border including a top border face and a bottom border face; a first attachment mechanism coupled to the bottom border face; at least one peg, the peg including a top peg face and a bottom peg face; and a second attachment mechanism coupled to the bottom peg face.

In yet another aspect of the present invention, a method for facilitating touch pad finger placement is provided. This method includes the following steps: adhering at least one of the group consisting of a border, at least one peg, and combinations thereof to a touch pad of a computer; placing at least one finger on the touch pad in a location determined by the at least one of the group consisting of the border, the at least one peg, and combinations thereof.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top view of a substantially rectangular border and a plurality of pegs attached to a perimeter of a touch pad of a computer and the area adjacent thereto in accordance with one embodiment of the present invention;

FIG. 2 depicts a top view of the border and the plurality of pegs depicted in FIG. 1 in a packaged and unattached state;

FIG. 3 depicts a side view of the border and the plurality of pegs depicted in FIG. 1 including rounded corners and a partially removed adhesive backing;

FIG. 4 depicts a top view of a substantially horseshoe-shaped border and plurality of pegs attached to a touch pad of a computer and the area adjacent thereto in accordance with an alternate embodiment of the present invention; and

FIG. 5 depicts a method of facilitating touch pad finger placement in accordance with one embodiment of the present invention.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a peg” includes a plurality of pegs. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

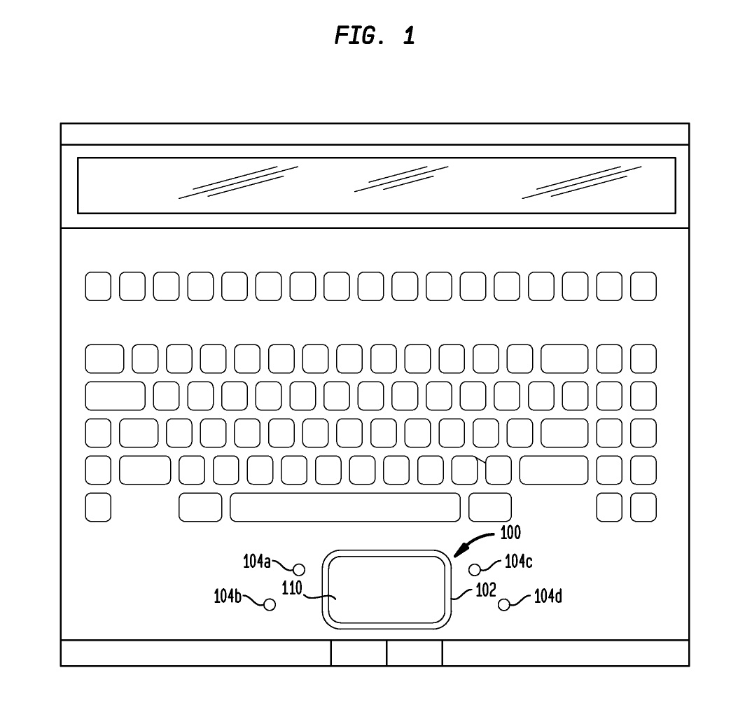

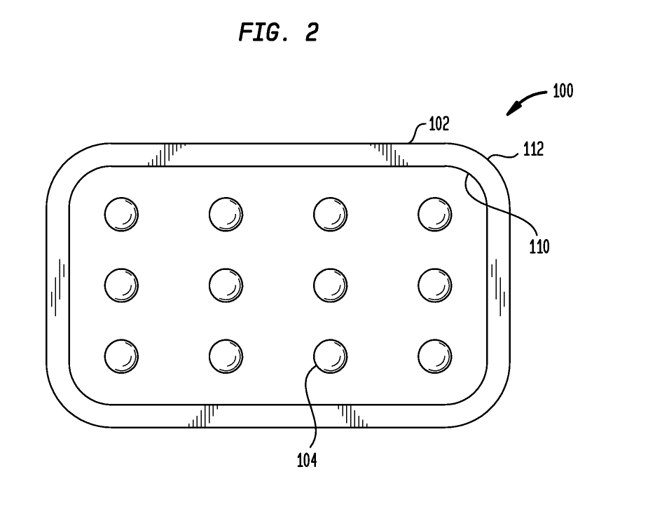

Referring first to FIG. 2, depicted is a top view of a system 100 for facilitating touch pad finger placement in accordance with one embodiment of the present invention. System 100 acts as a guide for individuals using a touch pad, for example, on a laptop computer. System 100 includes a border 102 and a plurality of pegs 104. In one use of the embodiment depicted in FIG. 2, border 102 and two pegs 104a and 104b are arranged as depicted in FIG. 1. This arrangement would be ideal for a person using her left hand to control the touch pad, and it would assist a user in maintaining a home position when using a laptop control area that includes a touch pad. Pegs 104a and 104b indicate to a user where to place two of his or her fingers (e.g., the pinky finger is placed upon peg 104a and the ring finger is placed upon peg 104b) while navigating the cursor via a third finger placed upon the touch pad. Border 102 surrounds the perimeter of the touch pad. In the depicted embodiment of the present invention, when a user's finger is in contact with border 102, it indicates to the user that his or her finger is approaching the perimeter of the touch pad. That is, if the third finger placed upon the touch pad contacts border 102, this contact alerts the user that the third finger has strayed, or is in the process of straying, from the usable area of the touch pad.

In an alternate arrangement ideal for a person using his or her right hand to control the touch pad, two pegs 104c and 104d indicate to a user where to place two of his or her fingers (e.g., the pinky finger is placed upon peg 104d and the ring finger is placed upon peg 104c) while navigating the cursor via a third finger placed upon the touch pad. Border 102 surrounds the perimeter of the touch pad. In the depicted embodiment of the present invention, when a user's finger is in contact with border 102, it indicates to the user that his or her finger is approaching the perimeter of the touch pad. That is, if the third finger placed upon the touch pad contacts border 102, this contact alerts the user that the third finger has strayed, or is in the process of straying, from the usable area of the touch pad.

System 100 is ideal for everyday computer users, as well as those with visual impairments. System 100 is also ideal for users who use their computers in a low light environment (e.g., a disc jockey). System 100 may be provided in a plurality of colors to allow a user to select a color that produces a strong contrast to the color of the area surrounding the touch pad. Such a contrast may assist a visually impaired user, or a user in a poorly lit environment, in locating system 100 and/or the touch pad. In some embodiments, the material of system 100 may be fluorescent to assist viewers in poorly light areas. System 100 provides convenience and eliminates the need for users to take their eyes off the screen while working

In the depicted embodiment, border 102 is substantially rectangular and has rounded interior corners 110 and exterior corners 112. The rounded interior corners 110 provide comfort and ease of use to the user when a user's finger contacts the interior surface of interior corner 110. That is, the rounded nature of interior corner 110 allows a user's finger to glide along the rounded corner easily to the desired location.

In the depicted embodiment of the present invention, border 102 and pegs 104 are cut from a sheet of adhesive backed felt. However, alternate embodiments of the present invention are envisioned in which border 102 and/or pegs 104 are made of different material(s) including, without limitation, foam or foam covered with felt.

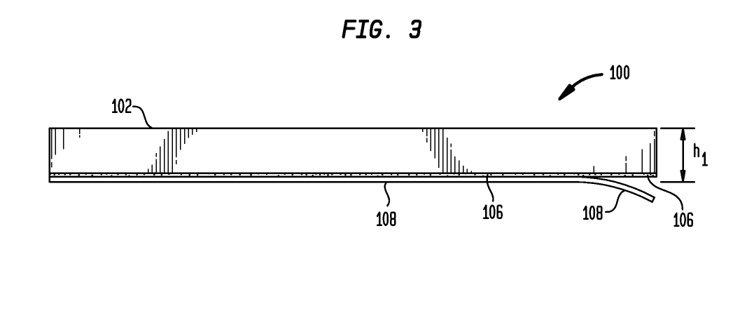

As best seen in the side view of FIG. 3, border 102 has a height h₁ of approximately 1/16 of an inch or 1/32 of an inch. However, borders 102 having varying heights may be substituted without departing from the scope hereof. In addition, pegs 104 may have the same height as border 102 or may have a shorter or taller height then border 102 without departing from the scope of the present invention.

Still referring to FIG. 3, the depicted embodiment of the present invention includes adhesive 106 and adhesive backing 108 on the downwardly facing surfaces of border 102 and pegs 104. When a user is ready to adhere border 102 or peg 104 to a touch pad or the area surrounding it, the user removes adhesive backing 108 to expose adhesive 106 located on the downwardly facing surface of border 102 or peg 104. This allows a user to affix border 102 around the perimeter of a laptop touch pad (e.g., laptop touch pad 110 as depicted in FIG. 1) and to affix pegs 104 to the surface of the laptop in a pattern desired by the user. One example of such a pattern is depicted in the top view of FIG. 1. However, varying patterns may be substituted without departing from the scope of the present invention including, but not limited to, adhering a border only to the perimeter of the touch pad (i.e., without the use of any pegs), adhering one or more pegs only to a surface of the laptop (i.e., without the use of a border), and adhering one or more pegs around the perimeter of a touch pad (i.e., without the use of a border).

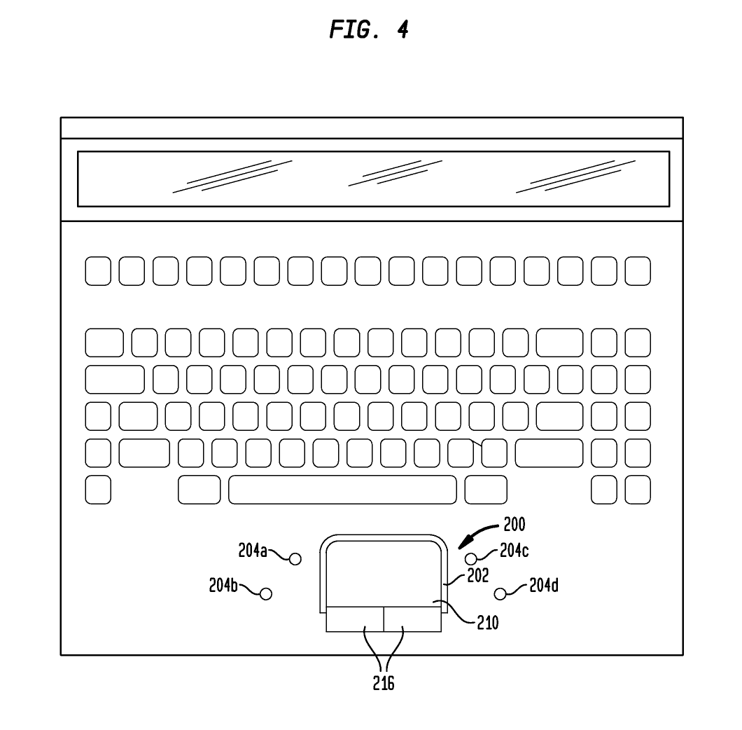

Referring now to FIG. 4, depicted is a top view of a system 200 for facilitating touch pad finger placement in accordance with an alternate embodiment of the present invention. System 200 includes a border 202 and a plurality of pegs 204. Pegs 204 are substantially identical to pegs 104 as described in greater detail above. Border 202 is substantially identical to border 102 as discussed in greater detail above with the exception that border 202 has a substantially horseshoe shape (whereas border 102 has a substantially rectangular shape). System 200 also acts as a guide for individuals using a touch pad, for example, on a laptop computer. However, the horseshoe shape eliminates the longitudinal edge located adjacent to the touchpad buttons 216 of touchpad 210. The horseshoe shape accommodates touch pads having buttons immediately below the touch pad (i.e., there is not sufficient space between the edge of the touch pad and the touch pad buttons to place border 202 therebetween).

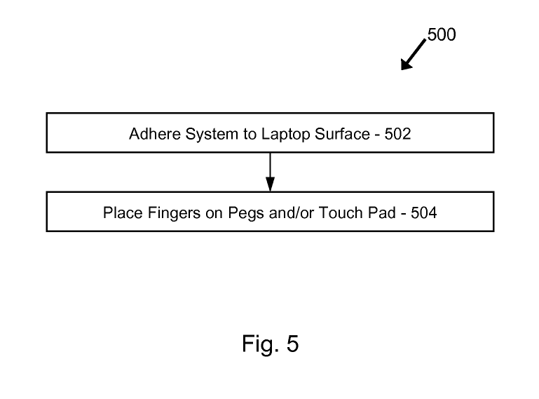

Referring now to FIG. 5, depicted is method 500 for facilitating touch pad finger placement. Method 500 begins at 502, at which a border and/or one or more pegs are adhered to the area surrounding a touch pad and/or the surface of the laptop, respectively. In the exemplary embodiment depicted in FIGS. 1 through 3 and discussed above, a border and/or one or more pegs are attached to the touch pad or surrounding area by removing the adhesive backing (to expose the adhesive) and placing the adhesive upon the desired surface. Thereafter, pressure may be applied to the top surface of the border and/or one or more pegs until the adhesive sets or dries, thereby affixing the touch pad and/or one or more pegs to the desired surfaces.

Next, at step 604, a user places one or more fingers on the touch pad and/or the pegs. The location(s) of each finger is determined relative to the location of the border and/or one or more pegs. When the user's finger placed upon the touch pad strays too far from a desired location, contact with the border alerts the user to the new location of the finger to allow the user to correct the finger's position. Or, when a user's finger that is placed atop a peg is no longer in contact with the peg, the user is notified that his or her finger has strayed and the user may relocate the finger atop the appropriate peg without viewing the touch pad (e.g., to assist a visually impaired user or to allow a user to keep his or her eyes on the screen).

Although the embodiments of the present invention have been described herein with regards to a touch pad of a computer, alternate embodiments of the present invention are envisioned for use with any type of touch pad. Additionally, alternate embodiments of the present invention are envisioned in which borders having varying shapes and sizes may be located around the perimeter of items such as buttons, slides, and the like to assist a user with location thereof. The invention is particularly useful when such buttons, slides, and the like are located flush with the surface of the laptop, however, the invention is not limited to flush components.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A system for facilitating touch pad finger placement comprising:
a border, said border including a top border face and a bottom border face; and
an attachment mechanism coupled to said bottom border face.

2. A system according to claim 1, wherein said attachment mechanism is an adhesive protected by a removable adhesive backing

3. A system according to claim 1, wherein a material of said border is selected from the group consisting of felt and foam.

4. A system according to claim 1, wherein said border is a shape selected from the group consisting of substantially rectangular with rounded corners, substantially rectangular with unrounded corners, and horseshoe.

5. A system for facilitating touch pad finger placement comprising:
at least one peg, said peg including a top peg face and a bottom peg face; and
an attachment mechanism coupled to said bottom peg face.

6. A system according to claim 5, wherein said attachment mechanism is an adhesive protected by a removable adhesive backing

7. A system according to claim 5, wherein a material of said at least one peg is selected from the group consisting of felt and foam.

8. A system according to claim 5, wherein said at least one peg is a shape selected from the group consisting of substantially semi-spherical, substantially cylindrical, substantially square, and combinations thereof.

9. A system for facilitating touch pad finger placement comprising:
a border, said border including a top border face and a bottom border face;
a first attachment mechanism coupled to said bottom border face;
at least one peg, said peg including a top peg face and a bottom peg face; and
a second attachment mechanism coupled to said bottom peg face.

10. A system according to claim 9, wherein at least one of the group consisting of said first attachment mechanism, said second attachment mechanism, and combinations thereof is an adhesive protected by a removable adhesive backing

11. A system according to claim 9, wherein a material of at least one of the group consisting of said border, said at least one peg, and combinations thereof is selected from the group consisting of felt and foam.

12. A system according to claim 9, wherein said border is a shape selected from the group consisting of substantially rectangular with rounded corners, substantially rectangular with unrounded corners, and horseshoe.

13. A system according to claim 9, wherein said at least one peg is a shape selected from the group consisting of substantially semi-spherical, substantially cylindrical, substantially square, and combinations thereof.

14. A method for facilitating touch pad finger placement comprising the steps of:
adhering at least one of the group consisting of a border, at least one peg, and combinations thereof to an area surrounding a touch pad;
placing a first finger on said touch pad in a location determined by said at least one of the group consisting of said border, said at least one peg, and combinations thereof.

15. A method according to claim 14 further comprising the step of:
placing at least one additional finger on one of said at least one peg.
